(19) United States
(12) Patent Application Publication
(10) Pub. No.: US 2008/0070746 A1
(43) Pub. Date: Mar. 20, 2008

(54) Power transmission system for vehicle and control method therefor

(75) Inventors: Masao Shiomi, Sagamihara-shi (JP); Shigeyuki Sakaguchi, Yokohama-shi (JP); Yosaburo Aoki, Ichikawa-shi (JP)

Correspondence Address: OSHA LIANG L.L.P., 1221 MCKINNEY STREET, SUITE 2800, HOUSTON, TX, 77010, US

(73) Assignee: Nissan Motor Co., Ltd., Yokohama-shi (JP)

(21) Appl. No.: 11/901,426

(22) Filed: Sep. 17, 2007

(30) Foreign Application Priority Data
Sep. 19, 2006 (JP) 2006-252955

(51) Int. Cl. F16H 61/664

(52) U.S. Cl. 477/43

(57) ABSTRACT

A method of controlling a power transmission system for a vehicle includes resuming fuel supply from a fuel cut condition during transition from an accelerator-off mode to an accelerator-on mode, setting a speed change inhibition time period of a continuously variable transmission (“CVT”) in correspondence to a speed change ratio, determining combustion attainment of an engine, and permitting variation of the speed change ratio of the CVT in accordance with the speed change inhibition time period and the determination of combustion attainment.

### PRIORITY APPLICATION

This application claims priority from Japanese Patent Application No. 2006-252955, filed Sep. 19, 2006, the contents of which are hereby incorporated by reference in its entirety.

### BACKGROUND OF INVENTION

1. Field of the Invention

The present invention relates to a speed change controller for a continuously variable transmission.

2. Description of the Related Art

Conventionally, a deceleration running mode of a vehicle engine (hereinafter “engine”) is detected by an idle switch or the like when the accelerator pedal is completely released. Upon detection of the deceleration running mode, a control temporarily stops or reduces a fuel supply to the engine. The control, which can be termed “deceleration fuel cut control,” is widely and popularly used to reduce fuel consumption, exhaust hydrocarbon (“HC”), and the like.

In a vehicle including a continuously variable transmission (“CVT”) having a lock-up function, in the deceleration running mode, a lock-up clutch is engaged to use the engine as a brake and a crankshaft of the engine is mechanically directly coupled with an input shaft of the CVT. In the event of acceleration from the deceleration running mode while the lock-up clutch remains in engagement, engine torque generated step-wise in conjunction with resumption of fuel supply and combustion may cause torsion vibrations in a drive system of the vehicle, thereby generating backward/forward vibrations of the vehicle body. The back and forth vibration of the vehicle body has a relatively large amplitude immediately after combustion in conjunction with the step-wise rise of engine torque. Therefore, when a request is issued for changing a speed change ratio of the continuously variable transmission in the event of acceleration, an inertial torque associated with the speed change overlaps negative vibration components of the vehicle body vibration, whereby the vehicle body vibration increases to the extent of reducing driver comfort.

To overcome problems such as described above, a technique is known that starts the speed change operation by setting a delay of a predetermined time period for occurrence of the speed change request made with an acceleration operation. Such a technique is disclosed in Japanese Patent Application Laid-Open (JP-A) No. 08-177996 at paragraph [0012]. The delay of the predetermined time period is set for the start of the speed change operation. The occurrence timing of the inertial torque associated with the speed change is compulsorily delayed with respect to the occurrence timing of the vehicle body vibration, thereby preventing the vehicle body vibration from being increased by the inertial torque.

The delay to be set for the start of the speed change operation is determined as a time period corresponding to a vibration frequency that is obtained as a reciprocal of a specific frequency of the drive system. Therefore, in the event that variations occur in ignitability upon resumption of combustion, and a delay occurs in time until combustion is actually achieved from the fuel supply resumption, the increase in the vehicle body vibration cannot be securely prevented corresponding to the event.

### SUMMARY OF THE INVENTION

In accordance with embodiments of the present invention, a power transmission system for a vehicle includes an engine, a CVT connected to the engine, an accelerator position sensor for detecting an accelerator position, a vehicle speed sensor for detecting a vehicle speed, a combustion attainment sensor, and a controller for issuing a speed change instruction to the CVT in accordance with the accelerator position and the vehicle speed. The controller is configured to set a speed change inhibition time period of the CVT when fuel supply is resumed from a fuel cut condition at a transition from an accelerator-off mode to an accelerator-on mode. The controller is further configured to permit variation of a speed change ratio of the CVT in accordance with the speed change inhibition time period and a determination of combustion attainment.

In accordance with embodiments of the present invention, a method of controlling a power transmission system for a vehicle includes resuming fuel supply from a fuel cut condition during transition from an accelerator-off mode to an accelerator-on mode, setting a speed change inhibition time period of a CVT in correspondence to a speed change ratio, determining combustion attainment of an engine, and permitting variation of the speed change ratio of the CVT in accordance with the speed change inhibition time period and the determination of combustion attainment.

In accordance with embodiments of the present invention, a power transmission system for a vehicle includes fuel supply resuming means for resuming fuel supply from a fuel cut condition during transition from an accelerator-off mode to an accelerator-on mode, speed change inhibition time period setting means for setting a speed change inhibition time period of a CVT in correspondence to a speed change ratio, combustion attainment determining means for determining combustion attainment of an engine; and speed change ratio variation permitting means for permitting variation of the speed change ratio of the CVT in accordance with the speed change inhibition time period and a determination of combustion attainment from the combustion attainment determination means.

Other aspects and advantages of the invention will be apparent from the following description and the appended claims.

### BRIEF DESCRIPTION OF DRAWINGS

FIG. 1 is a diagram showing a configuration of a power transmission system including a built-in CVT and a built-in automatic transmission control unit working as a speed change controller therefor in accordance with an embodiment of the present invention.

FIG. 2 is a speed change ratio setting map of the CVT in accordance with an embodiment of the present invention.

FIG. 3 is a diagram showing a lock-up area of a torque converter in accordance with an embodiment of the present invention.

FIG. 4 is a flow chart of a speed change control routine in accordance with an embodiment of the present invention.

FIG. 5 is a timing chart representing one example of operation of the automatic transmission control unit corresponding to the speed change control routine shown in FIG. 4.

FIG. 6 is a timing chart representing another example of operation of the automatic transmission control unit corresponding to the speed change control routine shown in FIG. 4.

FIG. 7 is an example of a transmission speed setting table.

FIG. 8 is a subroutine representing one example of operation in a speed changing step when the transmission speed is variable.

### DETAILED DESCRIPTION

The present invention relates to a vehicle power transmission system and a control method therefor that are capable of securely preventing an increase in vehicle body vibration in the event of acceleration associated with an accelerator (pedal) operation from the deceleration running mode of effecting deceleration fuel cutting in the manner of setting a delay taking ignitability in the event of resumption of combustion into account.

In accordance with an embodiment of the present invention, a power transmission system for a continuously variable transmission detects a cancellation of fuel supply stop by performing an accelerator operation involving a speed change request to the continuously variable transmission, and computes a speed change inhibition time period relevant to a specific frequency of vehicle body vibration due to combustion in correspondence to a speed change associated with the accelerator operation. Further, the system detects a time period (“combustion delay”, herebelow) from an instance of resumption of fuel supply by the cancellation to an instance of attainment of an actual combustion, and compensates for the speed change inhibition time period in accordance with the detected combustion delay, thereby to cause initiation of a speed change operation of the continuously variable transmission in response to the speed change request after an elapse of the speed change inhibition time period compensated for by the compensating means from the instance of resumption of fuel supply.

In accordance with an embodiment of the present invention, in the event of effecting acceleration by performing an accelerator operation from a deceleration running mode in the state where fuel supply to the engine is stopped, a cancellation of a fuel supply stop is detected, and fuel supply is resumed by the cancellation. After the resumption of fuel supply, the speed change operation of the continuously variable transmission is initiated in the timing awaiting the elapse of the speed change inhibition time period. The speed change inhibition time period is set in accordance with the combustion delay from the instance of resumption of fuel supply to the instance of actual combustion attainment, so that ignitability in the instance of resumption of fuel supply can be reflected for setting of the initiation timing of the speed change operation. Consequently, even in a case where variation takes place in ignitability after resumption of fuel supply and a delay due to the variation occurs in the time period until combustion is attained, an appropriate speed change inhibition time period can be set, and hence increase of vehicle body vibration associated with the action of inertial torques can be securely prevented.

Embodiments of the present invention will be described below with reference to the accompanying drawings.

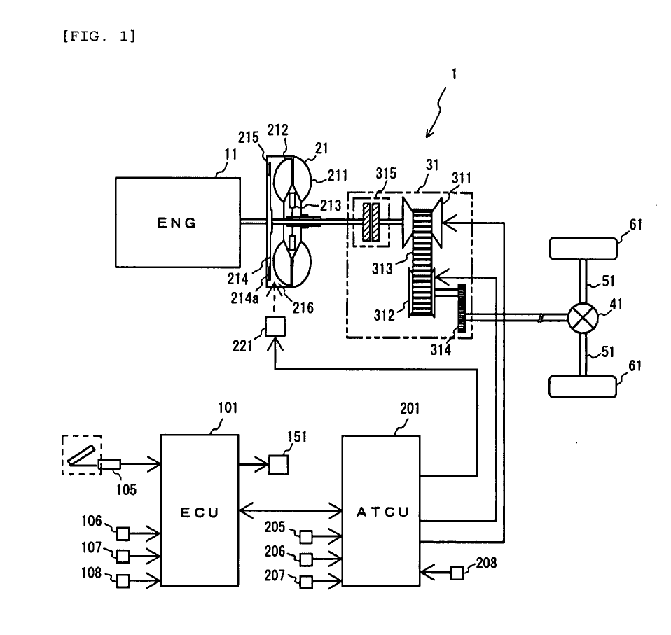

FIG. 1 is a diagram showing a configuration of a speed change controller for a CVT in accordance with one embodiment of the present invention. In the present embodiment, the CVT 31 and the speed change controller therefor are built-in in a vehicle power transmission system 1. The function of the speed change controller may be included in an automatic transmission (“AT”) control unit 201 (“ATCU”), which is described in detail below. Although the CVT 31 of a belt drive type is employed in the present embodiment, a CVT of a toroidal drive type can be also employed.

The power transmission system 1 has a configuration in which a crankshaft of an internal combustion engine 11 (“ENG”) (simply an “engine”, hereinbelow), which works as a drive source, is connected to the CVT 31 via a torque converter 21.

The torque converter 21 is provided as a starting element or component, and includes a pump impeller 211, a turbine runner 212, and a stator 213 as well as a lock-up clutch 214. The lock-up clutch 214 is coupled to the turbine runner 212. A clutch facing 214a is pressed on an inner face of a clutch housing 215 formed integrally with the pump impeller 211, thereby mechanically directly connecting together the crankshaft of the engine 11 and an input shaft of the CVT 31.

The CVT 31, which is the belt drive type, includes speed change components, namely, an input-side pulley 311, an output-side pulley 312, and a V-shaped metallic belt 313 wound on and extending between the input-side and output-side pulleys 311 and 312. A speed change ratio “ip” of the CVT 31 is altered by varying a pulley ratio between the input side and the output side. More specifically, the pulley ratio is a ratio between winding diameters of the metallic belt 313 on the input-side and output-side pulleys 311 and 312.

The input-side and output-side pulleys 311 and 312 each include a fixed member fixed to a rotation shaft, and a movable member provided slidably on the rotation shaft and coaxially with the fixed member. The winding diameter of the metallic belt 313 is varied in the manner that the movable member is hydraulically driven to move towards or away from the fixed member. The CVT 31 further includes a final gear 314, whereby post-speed change drive forces transferred by the input-side and output-side pulleys 311 and 312 are finally reduced.

In the present embodiment, the CVT 31 includes a forward clutch 315 configured as a multi-plate clutch. The forward clutch 315 operates to shift between neutral and drive ranges, thereby to establish connection or disconnection between an output shaft of the torque converter 21 and an input shaft of the CVT 31 (corresponding to a rotation shaft of the input-side pulley 311). In the state where the engagement of the forward clutch 315 is released, transmission of the drive forces from the engine 11 to the CVT 31 is discontinued, and the CVT 31 is set to the neutral range.

In the power transmission system 1 configured as described above, the drive forces generated by the engine 11 are transmitted to the CVT 31 via the torque converter 21, the speed ratio is the converted to the predetermined speed change ratio “ip” by the CVT 3, and then the forces are transmitted to left and right drive wheels 71, 71 via a differential gear 41 and drive shafts 51.

A speed change operation of the CVT 31 (or alteration of the pulley ratio, in the present case) and engagement and release of the lock-up clutch 214 are performed by way of respective hydraulic control valves (not shown), which are provided to the respective devices, in accordance with command signals received from the AT control unit 201.

The AT control unit 201 inputs various signals, such as a signal from a vehicle speed sensor 205 that detects a vehicle speed VSP; a signal from an inhibitor switching 206; a signal from a hydraulic oil sensor 207 that detects a temperature TF of a transmission hydraulic oil; and an input signal indicative of a rotation speed of the CVT 31, namely, a signal from a rotation speed sensor 208 that detects a rotation speed NT (turbine rotation speed) of the turbine runner 212. In addition, the AT control unit 201 inputs respective signals indicative of an accelerator opening APO and an engine speed NE from an engine control unit 101 (“ECU”) to be described later.

In accordance with the input signals indicative of the accelerator opening APO and the vehicle speed VSP, the AT control unit 201 executes predetermined computations for the speed change control and the like. As a consequence, the AT control unit 201 outputs command signals to respective hydraulic control valves for the input-side and output-side pulleys 311 and 312 and the lock-up clutch 214 of the torque converter 21.

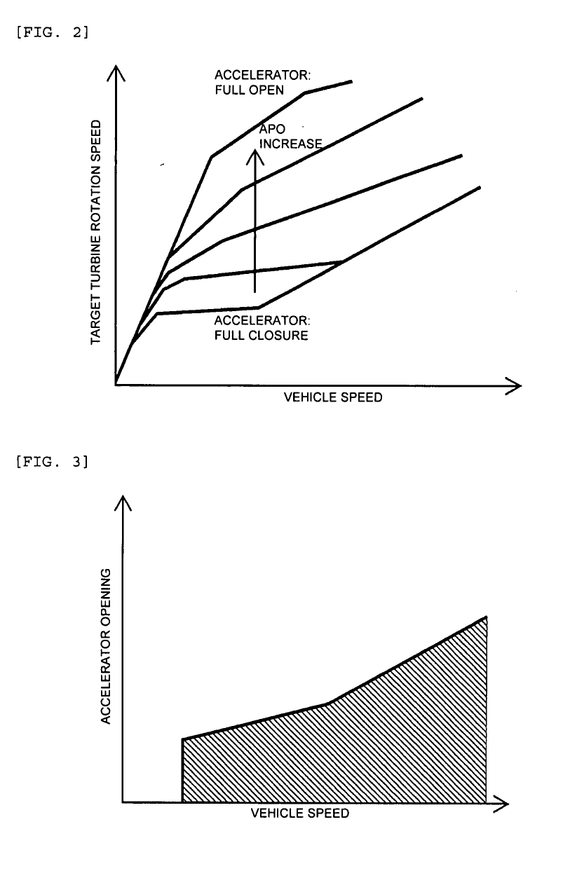

In the present embodiment, the AT control unit 201 provides speed change control in a manner such as described hereinbelow. The movable members of the respective input-side and output-side pulleys 311 and 312 are activated by way of a hydraulic control valve (not shown) to control the CVT 31 to a predetermined speed change ratio “ip” corresponding to a running condition of the vehicle. More specifically, for example, the AT control unit 201 may searches or reference tendency map data shown in FIG. 2 in accordance with the accelerator opening APO or the like. Then, the AT control unit 201 computes a target turbine rotation speed, and controls an input rotation speed (that is, the turbine rotation speed NT) of the CVT 31 to the computed target turbine rotation speed.

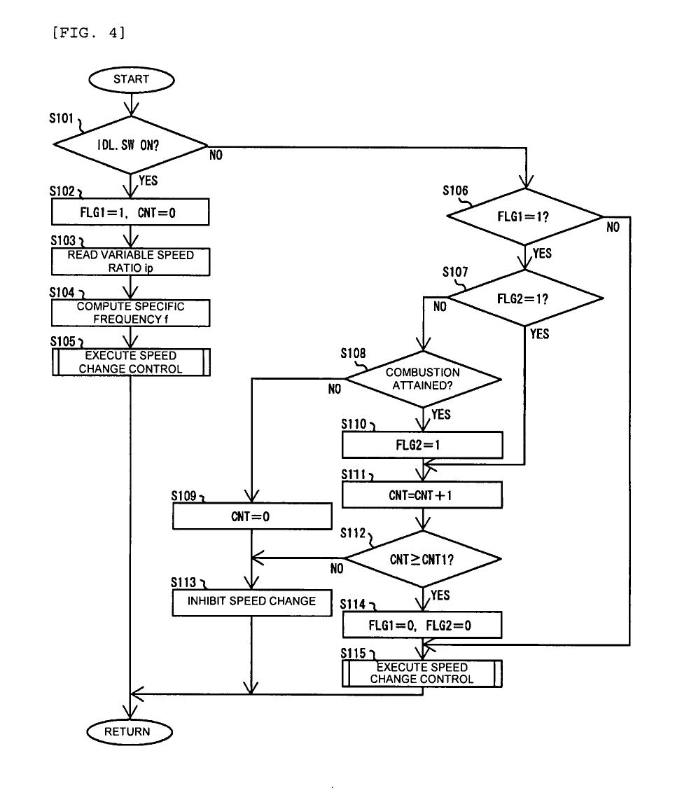

Further, the AT control unit 201 provides lock-up control by referencing tendency map data as shown, for example, in FIG. 3. When the running condition of the vehicle is in a low load area (hatched portion in the figure), which is predetermined corresponding to the accelerator opening APO in units of the vehicle speed VSP, the pressure in a clutch hydraulic chamber 216 is increased by way of a hydraulic control valve 221. Thereby, the lock-up clutch 214 is brought into engagement.

The engine control unit 101 controls the engine 11. The engine control unit 101 inputs various signals and thereby executes predetermined computations in accordance with the input signals. The signals to be input include, but not limited to, a signal from an acceleration sensor 105 that detects the amount of operation of the accelerator pedal (i.e., accelerator opening APO), a signal from a crank angle sensor 106 in units of a unit crank angle or reference crank angle (based on which the engine speed NE can be computed), and a signal from a water temperature sensor 107 that detects a temperature TW of engine cooling water.

Further, in the present embodiment, the configuration includes an idle switch 108 that outputs an ON signal at an accelerator full closure time for effecting deceleration fuel cutting. More specifically, the idle switch 108 outputs the ON signal in the state where the accelerator pedal is completely returned. The idle switch 108 is provided to a throttle sensor (not shown). A signal from the idle switch 108 is input to the engine control unit 101. In a normal mode, the engine control unit 101 outputs to an injector 151 a fuel injection control signal set in accordance with the accelerator opening APO, the engine speed NE, and the like. Alternately, when, at the accelerator full closure time, a predetermined fuel cut condition is satisfied, the engine control unit 101 stops an injection operation of the injector 151, thereby stopping fuel supply to the engine 11 and entering a deceleration fuel cut state. For example, the predetermined fuel cut condition may be a condition in which the engine speed NE is larger than or equal to a predetermined value. The deceleration fuel cut state may be cancelled in one of the following two instances. One instance is when the accelerator pedal is depressed and an output of the idle switch 108 is switched to an OFF signal. Another instance is when the engine speed NE is reduced to a predetermined value in the state where the accelerator pedal remains completely returned. After release of the deceleration fuel cut state, fuel supply to the engine 11 is resumed upon resumption of injection operation of the injector 151.

In the event of depressing the accelerator pedal while in the deceleration fuel cut state, vehicle body vibration is normally caused by the inertial torque associated with a speed change (specifically, a downshift). In the present embodiment, the speed change operation of the CVT 31 is inhibited for a predetermined time period (speed change inhibition time period) after resumption of fuel supply by depressing the accelerator pedal, thereby reducing or preventing vehicle body vibration.

Operation of the AT control unit 201 regarding inhibition of the speed change operation will be described herebelow with reference to the flow chart shown in FIG. 4. For description, it is assumed that the lock-up clutch 214 remains in engagement even during the deceleration running operation.

FIG. 4 is a flow chart of a speed change control routine to be performed by the AT control unit 201. The flow chart illustrates the operation of the AT control unit 201 when the accelerator pedal is depressed while in the deceleration fuel cut state. The AT control unit 201 executes the routine in units of a predetermined time period.

At step S101, the routine determines whether or not the output from the idle switch 108 is an ON signal. If the output is the ON signal, the routine proceeds to step S102. If the output is not the ON signal, the routine proceeds to step S106. In the event of the ON signal, when the predetermined fuel cut condition is satisfied in a fuel injection control routine to be separately executed by the engine control unit 101, the injection operation of the injector 151 is stopped to enter the deceleration fuel cut state.

At step S102, a speed change inhibition determination flag FLG1 is set to “1,” and a value CNT of a counter for measuring an elapsed time period after combustion attainment is set to “0.” The flag FLG1 is set to “1” at step S102 each time the ON signal is output form the idle switch 108. After the output from the idle switch 108 is switched to the OFF signal, the flag FLG1 is set to “0” upon permission of the speed change operation of the CVT 31.

At step S1103, a current speed change ratio “ip” is read out.

At step S104, a specific frequency “f” “f” of the drive system at the current speed change ratio “ip” is computed in accordance with the read-out speed change ratio “ip.” More specifically, the specific frequency “f” “f” is computed by retrieval of the specific frequency “f” “f” from map data in which specific frequencies “f” “f” are allocated corresponding to respective speed change ratios “ip.” The specific frequency “f” “f” can be evaluated through computation by approximating the configuration of the power transmission system 1 to a spring-mass vibration system. Alternatively, the specific frequency “f” can be evaluated by experimentation in which vehicle body vibration during acceleration is actually measured and analyzed.

At step S105, the CVT 31 is driven to perform normal speed change operations. More specifically, an accelerator opening APO and a vehicle speed VSP are read out. Then, map data, as shown in FIG. 2, is searched with the read-out accelerator opening APO and the like to compute a target turbine rotation speed (that is, speed change ratio “ip”) corresponding to a running condition. As a consequence, a command signal for achieving the computed target turbine rotation speed (speed change ratio “ip”) is output to the respective hydraulic control valves of the input-side and output-side pulleys 311 and 312.

At step S106, the routine determines whether or not the speed change inhibition determination flag FLG1 is “1.” If the flag FLG1 is “1,” (that is, in the event of inhibition of the speed change operation of the CVT 31), the routine proceeds to step S107. If the flag FLG1 is not “1,” the routine proceeds to step S115.

At step S107, the routine determines whether a combustion determination flag FLG2 is “1.” If the flag FLG2 is “1,” the routine proceeds to step S108. Normally, the flag FLG2 is set to “0,” but is switched to “1” when combustion attainment is determined after resumption of fuel supply by depressing the accelerator pedal.

At step S108, the routine determines whether or not combustion (specifically, an initial combustion) is actually attained. If the combustion is attained, the routine proceeds to step S110. If the combustion is not attained, the routine proceeds to step S109. The combustion attainment can be determined in accordance with an output of an intra-cylinder sensor, for example. Alternately, the combustion can be determined in another method. For example, combustion may be determined in accordance with a variation rate of the engine speed NE.

At step S109, the counter value CNT is reset to “0.”

At step S110, the combustion determination flag FLG2 is set to “1.”

At step S111, the counter value CNT is incremented by one.

At step S112, the routine determines whether or not a predetermined value CNT1 is reached by the counter value CNT. If the value CNT1 is reached, the routine proceeds to step S114. If the value CNT1 is not reached, the routine proceeds to step S113. The product of the multiplication of the counter value CNT times an execution cycle Δt corresponds to the elapsed time period after the combustion attainment. The value CNT1 corresponds to a value obtained by dividing the speed change inhibition time period predetermined as the reciprocal of the specific frequency of the drive system by the execution cycle Δt.

At step S113, since the speed change inhibition determination flag FLG1 is “1,” the speed change operation of the CVT 31 is inhibited. Concurrently, the speed change ratio “ip” is maintained at the value computed in the previous execution of the routine (that is, at the value before the accelerator operation).

At step S114, the speed change inhibition determination flag FLG1 and the combustion determination flag FLG2 are each reset to “0.”

At step S115, the CVT 31 is controlled to perform a speed change operation similarly as in step S105, whereby the speed change ratio “ip” after the accelerator operation is attained.

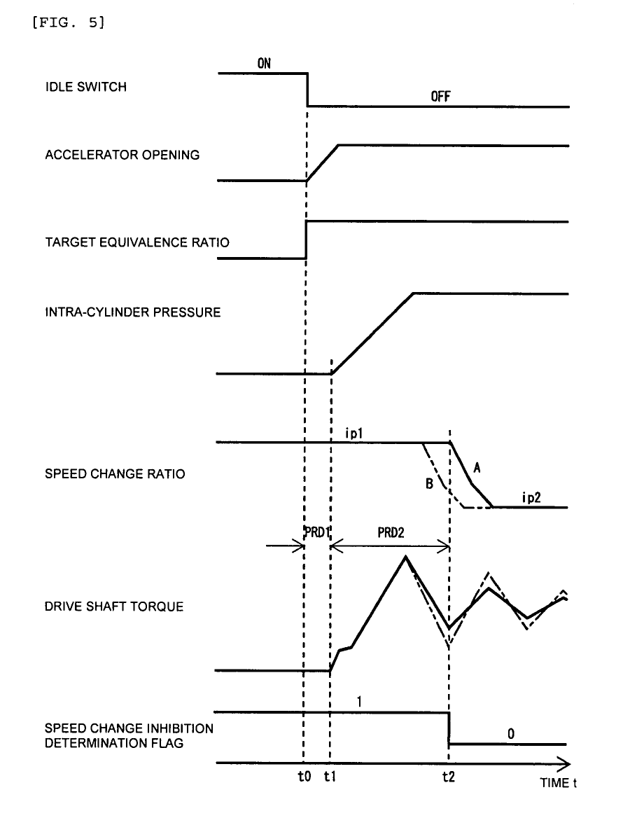

Operation of the AT control unit 201 in the event of effecting acceleration in response to depression of the accelerator pedal during deceleration fuel cutting will be described with reference to the timing chart shown in FIG. 5.

In a case where a predetermined fuel cut condition determined in regard to, for example, the engine speed NE is satisfied when the ON signal is output from the idle switch 108 in response to complete return of the accelerator pedal, the injection operation of the injector 151 is stopped, thereby to effect deceleration fuel cutting. Then, when the operation mode is changed to acceleration and the output from the idle switch 108 is turned to the OFF signal in response to depression of the accelerator pedal at time to, the deceleration fuel cut state is cancelled, thereby to resume fuel supply to the engine 11.

The AT control unit 201 monitors attainment of combustion in accordance with the output of the intra-cylinder pressure sensor (not shown). When it is determined that combustion is attained at time t1, the combustion determination flag FLG2 is set to “1” (step S110 in FIG. 4). Then, the counter value CNT is incremented by one in units of the execution of the speed change control routine (step S111 in FIG. 4). With the combustion thus attained, the engine torque rises stepwise, and the torque is transmitted to the drive system, thereby causing backward/forward vibrations of the vehicle body. By way of representation of the backward/forward vibrations, FIG. 5 shows a torque acting on the respective drive shaft 51. The AT control unit 201 operates such that the speed change operation of the CVT 31 is inhibited for a time period PRD2 substantially equal in length to the reciprocal of the specific frequency “f” (i.e., vibration frequency) of the drive system after attainment of combustion. In addition, at time t2 when the time period PRD2 has elapsed, the speed change inhibition determination flag FLG1 is changed to “0” to cancel the speed change inhibition, and the CVT 31 is controlled to initiate the speed change operation toward a post-accelerator operation speed change ratio ip2.

According to the present embodiment, after a delay, fuel supply to the engine 11 is resumed in response to the depression of the accelerator pedal. After combustion is attained, the speed change operation of the CVT 31 is resumed after the elapse of the speed change inhibition time period (=CNT1×Δt=PRD2). In the present embodiment, the speed change inhibition time period is set as the time period after combustion is attained by resumption of fuel supply. For this reason, vehicle body vibration resulting from the action of the inertial torque associated with the downshift can be prevented even when variation occurs in ignitability in the event of combustion resumption and variation is caused in initiation timing of vehicle body vibration due to combustion. The vibration is prevented in the manner that the influence of delay with respect to the speed change inhibition time period is eliminated, and the initiation timing of the speed change operation is appropriately set. In FIG. 5, a solid line A represents the speed change ratio “ip” in the case of the speed change controller of the present embodiment in which the speed change operation is initiated after the elapse of the change inhibition time period. On the other hand, a double-dotted line B represents a comparative example of a speed change ratio “ip,” without ignitability variation taken into account, in the case where the speed change operation is initiated with a delay corresponding to one cycle of the vehicle body vibration from resumption of fuel supply. The comparative example illustrates that inertial torques associated with the downshift are convolutionally exerted on negative vibration components, thereby increasing the vehicle body vibrations.

Further, according to the present embodiment, the speed change inhibition time period (=PRD2) is set to the time period equal in length to the reciprocal of the specific frequency “f” (i.e., vibration frequency) of the drive system. Thereby, reduction of a speed change response is restrained, and inertial torque is prevented from being convolutionally exerted on vibration components in an initial occurrence stage where the amplitude is relatively large. This effectively prevents an increase of vehicle body vibration.

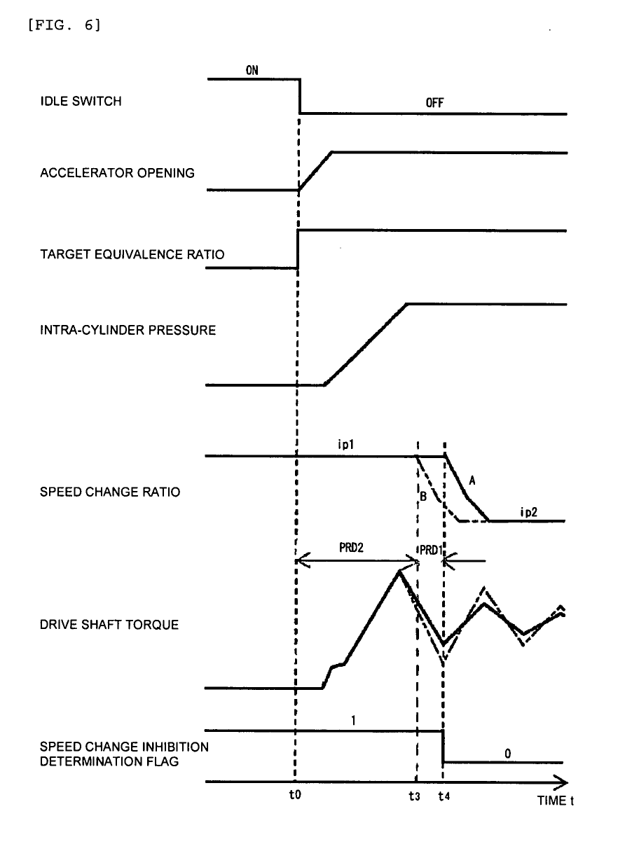

Further, according to the present embodiment, the speed change inhibition time period is set to the time period (=PRD2) after combustion, whereby the vehicle body vibration during acceleration can be reduced by relatively simple control. The speed change inhibition time period may be set to a longer time period (=PRD1+PRD2) after resumption of fuel supply. Alternatively, the speed change inhibition time period may be determined using a time period until combustion (i.e., combustion delay) is detected. The speed change inhibition time period determined under the assumption that no combustion delay occurs is then compensated for by extending the speed change inhibition time period by the detected combustion delay. For example, with reference to FIG. 6, when the output from the idle switch 108 is changed to the OFF signal at time t0, the fuel cut state is cancelled. Then, a speed change operation of the CVT is permitted to start at time t4 by which a further wait time or time period PRD1, which corresponds to the combustion delay, has elapsed from time t3 by which the speed change inhibition time period PRD2 elapsed from the time 0. Thereby, the ignitability variation in the event of resumption of combustion can be reflected for setting of the initiation timing of the speed change operation, so that an appropriate speed change inhibition time period can be set.

In the above, in the event of the downshift in response to depression of the accelerator pedal, the time period until the speed change ratio ip2 is attained (namely, shift speed Rt) is constant. However, the transmission speed Rt of the CVT 31 can be variable. For example, the control may be provided such that a combustion delay (corresponding to the time period PRD1 shown in FIG. 5) until actual combustion is attained from the instance of resumption of fuel supply after depression of the accelerator pedal is detected, and the transmission speed Rt is increased to be higher as the detected time period is increased. More specifically, for example, transmission speeds Rt corresponding to respective combustion delays, as shown in FIG. 7, are preliminarily set in the form of table data. During actual operation, a combustion delay DLY is detected. The table data is searched with the detected combustion delay DLY to compute a transmission speed Rt. The combustion delay DLY can be detected in accordance with, for example, the output of the intra-cylinder pressure sensor. Accordingly, regardless of ignitability variations, the time period until the post-downshift speed change ratio is attained from the depression of the accelerator pedal can be maintained substantially constant and, hence, deterioration of acceleration response can be mitigated.

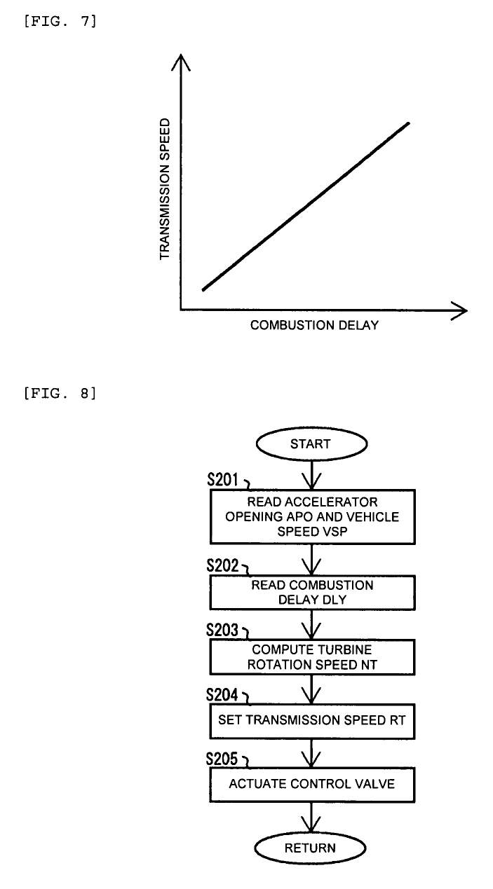

FIG. 8 is a subroutine representing the speed changing step (step S115 in FIG. 4) of the speed change control routine in the case where the transmission speed Rt is variable. According to the subroutine, the AT control unit 201 reads running conditions, namely, an accelerator opening APO and a vehicle speed VSP (step S201), and further reads a combustion delay DLY (S202). In accordance with the read-out accelerator opening APO and the like, a target turbine rotation speed is computed and a post-downshift speed change ratio is set (step S203). Then, the table data, as shown in FIG. 6, is searched with the combustion delay DLY, and a transmission speed Rt is computed (step S204). In accordance with the computed transmission speed Rt, the respective hydraulic control valves of the input-side and output-side pulleys 311 and 312 are driven, thereby to attain the downshift (step S205).

It is to be understood that the invention is not limited to the illustrated and described forms of the invention contained herein. It will be apparent to those skilled in the art that various alterations and modification may be made without departing from the scope of the invention, and the invention is not considered limited to what is shown in the drawing and described in the specification. Accordingly, the scope of the invention should be limited only by the attached claims.

What is claimed is:

1. A power transmission system for a vehicle, comprising:
an engine;
a continuously variable transmission (“CVT”) connected to the engine;
an accelerator position sensor for detecting an accelerator position;
a vehicle speed sensor for detecting a vehicle speed;
a combustion attainment sensor; and
a controller for issuing a speed change instruction to the CVT in accordance with the accelerator position and the vehicle speed,
wherein the controller is configured to set a speed change inhibition time period of the CVT when fuel supply is resumed from a fuel cut condition at a transition from an accelerator-off mode to an accelerator-on mode, and
wherein the controller is configured to permit variation of a speed change ratio of the CVT in accordance with the speed change inhibition time period and a determination of combustion attainment.

2. The power transmission system according to claim 1, wherein the controller is configured to permit initiation of variation of the speed change ratio of the CVT after an elapse of the speed change inhibition time period from the determination of combustion attainment.

3. The power transmission system according to claim 1, wherein the controller is configured to permit variation of the speed change ratio of the CVT after an elapse of the speed change inhibition time period after the fuel supply is resumed and a further elapse of a time period after the fuel supply is resumed to the determination of combustion attainment.

4. The power transmission system according to claim 1, wherein the controller is configured to set the speed change inhibition time period to be a time period equal in length to a reciprocal of a specific frequency of a drive system at the speed change ratio of the CVT when the fuel supply is resumed.

5. The power transmission system according to claim 1, wherein the controller is configured to set a speed change ratio variable speed of the CVT in accordance with a combustion attainment time period from when the fuel supply is resumed to the determination of combustion attainment.

6. The power transmission system according to claim 5, wherein the controller is configured to increase the speed change ratio variable speed of the CVT in proportion to a length of the combustion attainment time period.

7. A method of controlling a power transmission system for a vehicle, comprising;
resuming fuel supply from a fuel cut condition during transition from an accelerator-off mode to an accelerator-on mode;
setting a speed change inhibition time period of a continuously variable transmission (“CVT”) in correspondence to a speed change ratio;
determining combustion attainment of an engine; and
permitting variation of the speed change ratio of the CVT in accordance with the speed change inhibition time period and the determination of combustion attainment.

8. The method according to claim 7, wherein the permitting variation of the speed change ratio of the CVT occurs after an elapse of the speed change inhibition time period from the determination of combustion attainment.

9. The method according to claim 7, wherein the permitting variation of the speed change ratio of the CVT occurs after an elapse of the speed change inhibition time period after the fuel supply is resumed and a further elapse of a time period after the fuel supply is resumed to the determination of combustion attainment.

10. The method according to claim 7, further comprising:
setting the speed change inhibition time period to be a time period equal in length to a reciprocal of a specific frequency of a drive system at a speed change ratio of the CVT when the fuel supply is resumed.

11. The method according to claim 7, further comprising:
setting a speed change ratio variable speed of the CVT in accordance with a combustion attainment time period from when the fuel supply is resumed to the determination of combustion attainment.

12. The method according to claim 11, further comprising:
increasing the speed change ratio variable speed of the CVT in proportion to a length of the combustion attainment time period.

13. A power transmission system for a vehicle, comprising:
fuel supply resuming means for resuming fuel supply from a fuel cut condition during transition from an accelerator-off mode to an accelerator-on mode;
speed change inhibition time period setting means for setting a speed change inhibition time period of a continuously variable transmission (“CVT”) in correspondence to a speed change ratio;
combustion attainment determining means for determining combustion attainment of an engine; and
speed change ratio variation permitting means for permitting variation of the speed change ratio of the CVT in accordance with the speed change inhibition time period and a determination of combustion attainment from the combustion attainment determination means.

14. The power transmission system according to claim 13, wherein speed change ratio variation permitting means permits variation of the speed change ratio of the CVT after an elapse of the speed change inhibition time period from the determination of combustion attainment.

15. The power transmission system according to claim 13, wherein the speed change ratio variation permitting means permits variation of the speed change ratio of the CVT after an elapse of the speed change inhibition time period after the fuel supply is resumed and a further elapse of a time period after the fuel supply is resumed to the determination of combustion attainment.

16. The power transmission system according to claim 13, wherein the speed change inhibition time period setting means sets the speed change inhibition time period to be a time period equal in length to a reciprocal of a specific frequency of a drive system at a speed change ratio of the CVT when the fuel supply is resumed.

17. The power transmission system according to claim 13, further comprising:
speed change ratio variable speed setting means for setting a speed change ratio variable speed of the CVT in accordance with a combustion attainment time period from when the fuel supply is resumed to the determination of combustion attainment.

18. The power transmission system according to claim 17, wherein the speed change ratio variable speed setting means increases the speed change ratio variable speed of the CVT in proportion to a length of the combustion attainment time period.
